(19) United States
(12) Patent Application Publication
(10) Pub. No.: US 2021/0261042 A1
(43) Pub. Date: Aug. 26, 2021

(54) SAFETY SECURING STRUCTURE DEVICE FOR CONTAINER OF ARM-ROLL VEHICLE

(71) Applicant: Minjeong KIM, Wonju-si (KR)

(72) Inventor: Minjeong KIM, Wonju-si (KR)

(21) Appl. No.: 17/261,977

(22) PCT Filed: Jul. 24, 2019
(86) PCT No.: PCT/KR2019/009145

§ 371 Date: Jan. 21, 2021

(30) Foreign Application Priority Data
Jul. 30, 2018 (KR) 10-2018-0088448

(51) Int. Cl. B60P 7/13; B60P 7/18

(52) U.S. Cl. CPC B60P 7/13; B60P 7/18

(57) ABSTRACT

The present invention relates to a safety securing structure for the container of an arm-roll vehicle that is configured between an arm-roll vehicle and a container and maintains the state in which the container is integrated with the arm-roll vehicle, so that the structure of the arm-roll vehicle is improved such that the rotation moment generated by shock, vibration, or cornering during the driving of the arm-roll vehicle does not affect the container, thereby improving safety to prevent safety-related accidents caused by the container during the driving of the arm-roll vehicle. The safety securing structure device maintains a fixed state when the container is mounted on the arm-roll vehicle in order to collect waste such as solid or liquid waste, sludge, etc., and includes: at least one hook means (30) for providing vertical fixing force between the arm-roll vehicle (10) and the container (20).

### TECHNICAL FIELD

The present invention relates to a securing structure device that is safe when a container (arm-roll box) for an arm-roll vehicle is mounted and the arm-roll vehicle is running, and more particularly to a securing structure device between an arm-roll vehicle and a container that is configured between an arm-roll vehicle and a container and maintains the state in which the container is integrated with the arm-roll vehicle, and thus there is provided a safety securing structure device that prevents the spacing or separation between the arm-roll vehicle and the container that may be generated by shock, vibration, or cornering during the driving of the aim-roll vehicle, so that a structure is improved to prevent secondary traffic accidents and also protect the lives of people in advance, thereby improving safety by preventing safety-related accidents that occur during the driving or operation of the aim-roll vehicle.

### BACKGROUND ART

Generally, according to the definition of the International Organization for Standardization (ISO), ‘a container has durability and strength to withstand repeated use, can be linked to one or more transportation methods, and is specially designed to transport goods without refilling in the middle of transfer. It is equipped a device that enables easy handling when a transportation method is changed from one transportation method in which a handling method is particular to another transportation method, is designed for easy filling and removal of goods, and is transportation equipment having a volume of 35.3 cubic bits or more.’

There are various containers depending on the type of cargo to be accommodated, the main transportation organization, structure, material, loading capacity, shape, etc. Containers having a volume of 3 m³ or less are called small containers, and containers having more than 3 m³ are called large containers.

Advantages of the container transportation include the mechanization of loading and unloading, the reduction of packaging costs, and the prevention of theft.

There are various types of containers, such as tank containers for transporting liquid cargo, refrigerated containers for transporting cargo requiring temperature control, containers for transporting cargo not requiring temperature control, and ceiling- or side-open containers.

The container to be dealt with herein is widely used as a cleaning box or an arm-roll box.

Meanwhile, in order to collect household waste or construction waste generated in everyday life or a construction site and transport it to a landfill or treatment site, a collection container is installed on a corresponding site, loaded with the waste, and towed by a dedicated truck, i.e., an arm-roll truck, and accordingly the waste is transferred to a dedicated treatment site and disposed or recycled.

Therefore, in order to overcome the problems such as safety-related accidents occurring in the process of transporting collected waste to a landfill or treatment site after loading the collected waste into a large container (arm-roll box) as described above, there is required a functional apparatus that enables a container to be safely mounted on a vehicle so that the mounted container is not shaken, thereby preventing a driver's anxiety and also preventing safety accidents (large accidents on roads) in advance by preventing the container from being separated.

In this case, the arm-roll truck (vehicle) is now described in greater detail.

For example, since a spreader is temporarily used during the winter season, it is common to load and use the spreader on a truck equipped with a loading box and then unload and store the spreader after the winter season.

Accordingly, in order to reduce the damage caused by unexpected heavy snowfall and snowing in winter, it is very important to mobilize spreaders and eliminate the freezing of road surfaces.

Conventionally, when such a spreader is loaded into or unloaded from a vehicle, a traction device, such as a crane, and a large number of manpower are employed, and thus problems arise in that equipment rental and labor costs are increased and it takes a lot of time.

Accordingly, a truck that compensates for the disadvantages of a conventional truck from which a container can be separated is an arm-roll vehicle equipped with an arm roll.

As shown in FIG. 1, the conventional arm-roll vehicle 10 includes a loading unit 11 provided with a hook 12 used to load an arm-roll container 20, a hydraulic cylinder (not shown) configured to pull or push the loading unit 11, and a frame roller 14 configured to facilitate the loading and unloading of the arm-roll container 20 when the arm-roll container 20 is mounted on, loaded into, or unloaded from both frames of the hydraulic cylinder.

The arm-roll vehicle 10 configured as described above allows the arm-roll container 20 to be loaded or unloaded by hooking a hook 12 installed on the loading unit 11 onto a hook ring 21 formed on the arm-roll container 20.

In this case, one side of the bottom surface of the arm-roll container 20 to be loaded or unloaded is supported on rollers 14 provided on the subframe 13 of the arm-roll vehicle 10, and the other side thereof comes into contact with the top surface of the subframe 13 and slides.

However, only the securing structure that simply pushes between the arm-roll vehicle 10 and the arm-roll container 20 mounted on the arm-roll vehicle 10 and the securing method that uses the hook 12 and the hook ring 21 are adopted. Accordingly, fixing force is weak. The hook ring of the container is highly abrasion due to repeated towing work, so that it is easily damaged even with a small impact, with the result that problems arise in that the container is separated and a serious accident may be caused to the following vehicle when the container is separated from the vehicle.

In particular, when waste is loaded into the arm-roll container 20, a serious secondary safety-related accident is caused.

In other words, when waste such as solid or liquid waste, sludge, or the like is loaded into the arm-roll container 20, the center of gravity of the arm-roll container 20 is moved rearward by the loaded solid waste. In this case, a rotation moment is applied to the arm roll container 20 around the hook 12 and the hook ring 21 due to the shock or vibration generated during the driving of the arm-roll vehicle 10. As a result, problems arise in that a primary accident in which the arm-roll container 20 falls from the arm-roll vehicle 10 occurs and also a secondary accident occurs due to the fallen arm-roll container 20.

Moreover, when the fixing force of the arm-roll container 20 for the arm-roll vehicle 10 is weak, the arm-roll vehicle 10 causes the arm-roll container 20 to be pulled to one side by cornering as in a curved road, and thus there may be caused a safety-related accident such as an accident in which the arm-roll vehicle 10 is overturned.

### DISCLOSURE

### Technical Problem

The present invention is proposed to overcome the above-described problems, and an object of the present invention is to provide a safety securing structure for the container of an arm-roll vehicle that is configured between an arm-roll vehicle and a container and maintains the state in which the container is integrated with the arm-roll vehicle, so that the structure of the arm-roll vehicle is improved such that the rotation moment generated by shock, vibration, or cornering during the driving of the arm-roll vehicle does not affect the container, thereby improving safety to prevent safety-related accidents caused by the container during the driving of the arm-roll vehicle.

### Technical Solution

In order to accomplish the above object, the present invention provides a safety securing structure device for a container of an arm-roll vehicle, the safety securing structure device maintaining a fixed state when the container is mounted on the arm-roll vehicle in order to collect waste such as solid or liquid waste, sludge, etc., the safety securing structure device including: at least one hook means for providing vertical fixing force between the arm-roll vehicle and the container.

In the present invention, at least one catch means for providing horizontal fixing force is preferably included between the arm-roll vehicle and the container.

In the present invention, the hook means preferably includes: a first cylinder fixed to one side of the arm-roll vehicle, and configured to provide reciprocating force; a first piston configured at one end of the first cylinder, and configured to be reciprocated by the reciprocating force provided by the first cylinder; and a hook bracket configured at one end of the first piston, and configured to be rotated by a predetermined angle in response to the reciprocation of the first piston and selectively press and release the pressing of the container frame of the container mounted on the arm-roll vehicle.

In the present invention, the hook bracket preferably includes: a first hinge configured to provide support to be hinged to the first piston; and a second hinge configured to provide support to be hinged to one side of the arm-roll vehicle so that a reaction occurs in the hook bracket in response to the forward or backward action of the first piston, thereby allowing the pressing or releasing action of the container frame to be smoothly performed.

In the present invention, the catch means preferably includes: a second cylinder configured on one side of the arm-roll vehicle, and configured to provide reciprocating transfer force; a second piston configured at one end of the second cylinder, and configured to be transferred in a reciprocating manner by the reciprocating transfer force provided by the second cylinder; and an insertion protrusion configured at one end of the second piston, and configured to provide support so that horizontal fixing force is applied to the container while being transferred in a reciprocating manner in response to the reciprocation of the second piston.

In the present invention, an insertion hole configured such that the insertion protrusion enters thereto and exits therefrom so that a horizontal fixed state is maintained between the arm-roll vehicle and the container is preferably formed on one side of the container frame.

### Advantageous Effects

According to the present invention, there is achieved the effect of providing the safety securing structure device that is configured between an arm-roll vehicle and a container and maintains the state in which the container is integrated with the arm-roll vehicle, so that the structure of the arm-roll vehicle is improved such that the rotation moment generated by shock, vibration, or cornering during the driving of the arm-roll vehicle does not affect the container, thereby improving safety to prevent safety-related accidents caused by the container during the driving of the arm-roll vehicle.

### DESCRIPTION OF DRAWINGS

FIG. 1 is a view showing a state in which a container is mounted on a conventional arm-roll vehicle;

FIG. 2 is a schematic diagram of an arm-roll vehicle according to the present invention;

FIG. 3 is a plan view showing the main part of an arm-roll vehicle on which a container according to the present invention is mounted;

FIGS. 4a and 4b are partially enlarged views showing the operational states of a hook means according to the present invention;

FIGS. 5a and 5b are partially enlarged views showing the operational states of a catch means according to the present invention; and

FIG. 6 is an enlarged view of the main part of a catch means according to the present invention.

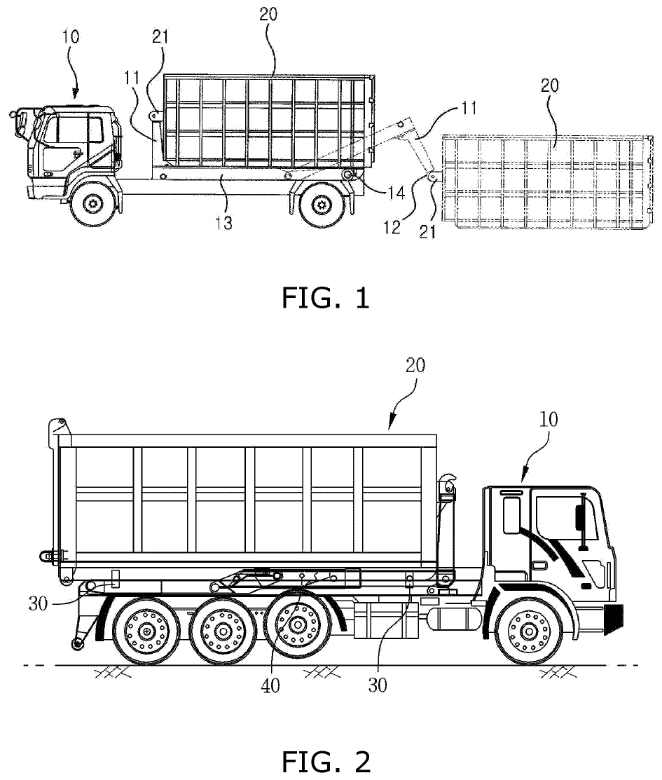

### MODE FOR INVENTION

Advantages and features of the present invention, and a method for achieving the same will become apparent with reference to the embodiments described later in detail in conjunction with the accompanying drawings.

However, the present invention is not limited to the embodiments disclosed below, but may be implemented in various different forms. However, these embodiments are provided to make the disclosure of the present invention complete and to fully inform the scope of the invention to those of ordinary skill in the art. The present invention is only defined by the scope of the claims. The same reference numerals refer to the same components throughout the specification.

Accordingly, in some embodiments, well-known steps, well-known structures, and well-known technologies have not been described in detail in order to avoid the obscure interpretation of the present invention.

The terms used therein are intended to describe embodiments, and are not intended to limit the present invention. In this specification, the singular form also includes the plural form unless particularly described in the corresponding passage.

The “comprise” and/or “comprising” used herein are used in a sense not to exclude the presence or addition of one or more other components, steps, operations, and/or elements other than the described components, steps, operations, and/or elements.

Furthermore, the “and/or” includes each and all combinations of one or more of stated items.

In addition, the embodiments described herein will be described with reference to sectional views and/or schematic diagrams which are ideal exemplary diagrams of the present invention.

Accordingly, the embodiments of the present invention are not limited to the illustrated specific forms, but include changes in form generated according to manufacturing processes.

In addition, in each of the drawings shown in the present invention, each component may be somewhat enlarged or reduced by taking into consideration of convenience of description.

Preferred embodiments of the present invention will be described in detail below with reference to the accompanying drawings as follows (the same reference numerals are used for components identical to those of the prior art, and detailed descriptions thereof will be omitted).

The safety securing structure device for the container of an arm-roll vehicle according to the present invention is configured between an arm-roll vehicle 10 and a container 20 and maintains the state in which the container 20 is integrated with the arm-roll vehicle 10, so that the structure of the arm-roll vehicle is improved such that the rotation moment generated by shock, vibration, or cornering during the driving of the arm-roll vehicle 10 does not affect the container 20, thereby preventing safety-related accidents caused by the container 10 during the driving of the arm-roll vehicle 10 and improving safety.

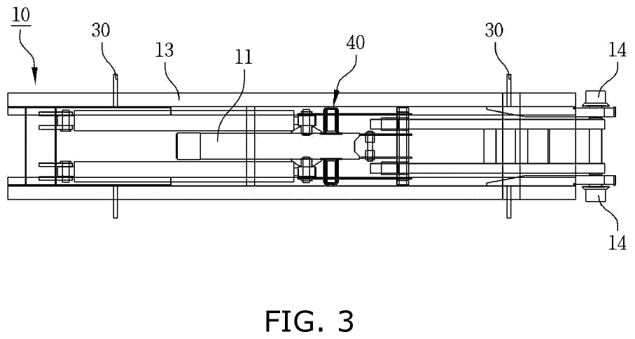

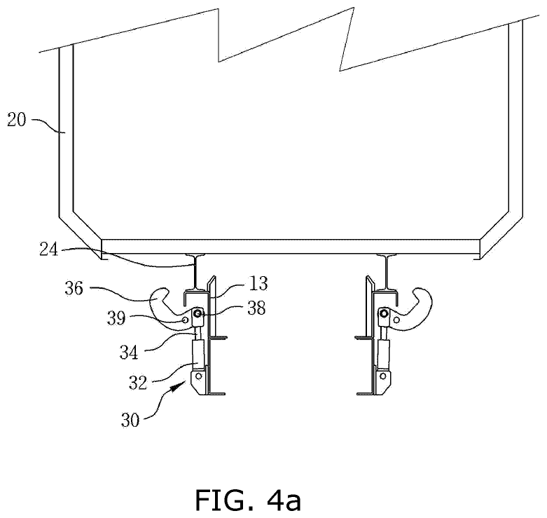

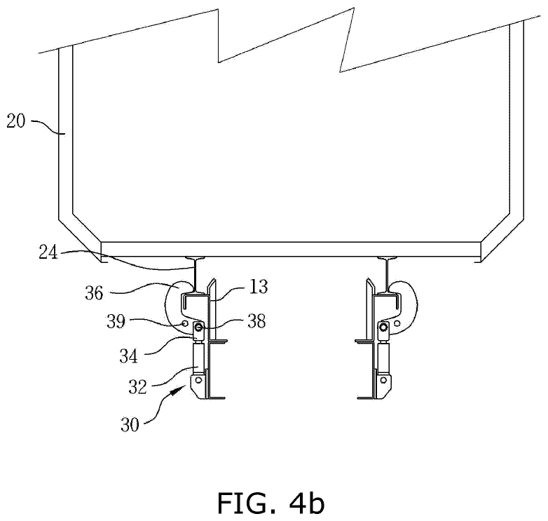

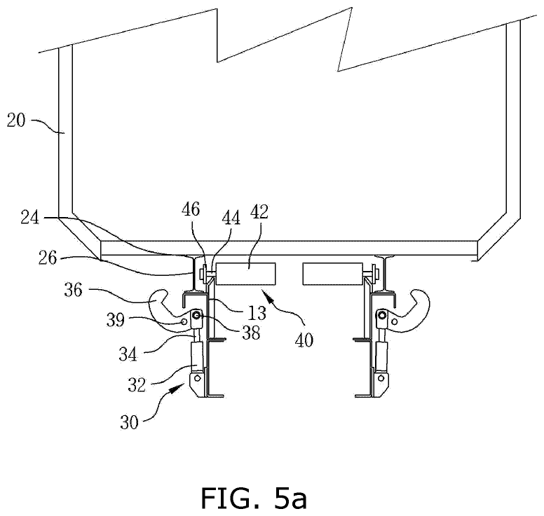

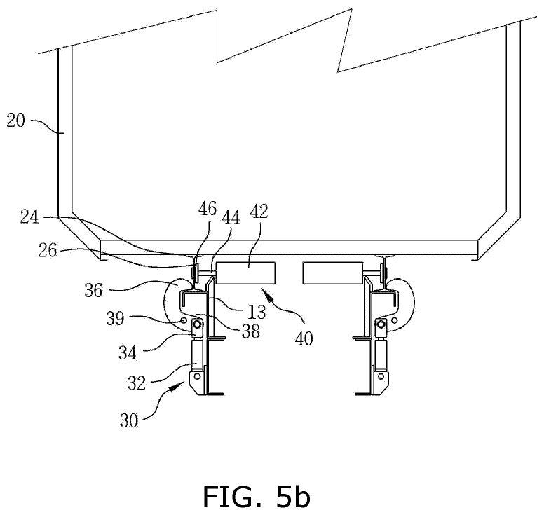

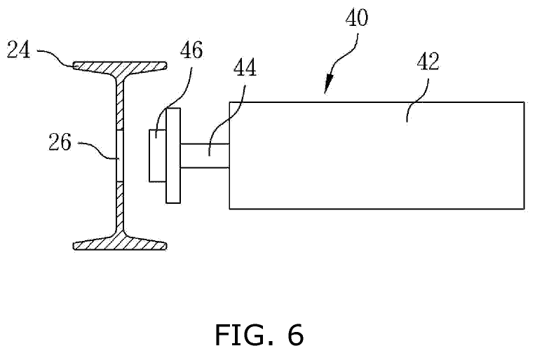

As shown in FIGS. 2 to 6, the safety securing structure device for an arm-roll vehicle is configured between the arm-roll vehicle 10 and the container 20 using any one or a combination of a hook means 30 and a catch means 40, thereby maintaining a state in which the container 20 is integrated with and fixed to the arm-roll vehicle 10.

Furthermore, the safety securing structure device for an arm-roll vehicle is preferably configured in front, rear and intermediate portions between the arm-roll vehicle 10 and the container 20.

In this case, the safety securing structure device for an arm-roll vehicle is configured using the hook means 30 in a front frame and using an extension catch means 40 and an insertion protrusion means in the intermediate portion and the rear portion, thereby preventing the container from being pushed and separated.

It is obvious that the present invention is not limited thereto and any configuration or structure capable of maintaining a securely fixed state on the arm-roll vehicle 10 and the container 20 may be used as the safety securing structure device for an arm-roll vehicle.

The hook means 30 includes a first cylinder 32 configured on one side of the arm-roll vehicle 10, a first piston 34 configured on one side of the first cylinder 32, and a hook bracket 36 configured at one end of the first piston 34.

The first cylinder 32 is fixed to one side of the arm-roll vehicle 10 and performs the function of providing reciprocating force by hydraulic pressure applied therein.

The first piston 34 is configured at one end of the first cylinder 32, and performs the function of rotating a hook bracket 36, configured at one end, by a predetermined angle while being reciprocated by the reciprocating force provided by the first cylinder 32.

The hook bracket 36 is configured at one end of the first piston 34 and is rotated by a predetermined angle by the reciprocating force applied by the first piston 34, so that fixing or releasing action is performed by pressing the container frame 24 configured on the bottom of the container 20, thereby allowing the process of integrating the container 20 with the arm-roll vehicle 10 to be performed.

A first hinge 38 configured to be hinged to the first piston 34 is configured at one end of the hook bracket 36.

Furthermore, a second hinge 39 configured to be hinged to a subframe 13 configured on one side of the arm-roll vehicle 10 is configured on one side of the hook bracket 36.

Furthermore, one end of the hook bracket 36, i.e., one side of the container frame 24 of the container 20, is configured in a streamlined catch hook form in order to provide not only easy insertion but also pressing force.

Accordingly, when advance force is applied by the first piston 34, the pressing action of the container 20 is released from the second hinge 39 as the other end of the hook bracket 36 is moved away from the container 20 by a reaction.

In contrast, when reverse force is applied by the first piston 34, the arm-roll vehicle 10 presses one side of the container frame 24 of the container 20 as the other end of the hook bracket 36 is inserted into the container 20 side around the second hinge 39 by a reaction, thereby performing the process of integrating the container 20 with the arm-roll vehicle 10.

Accordingly, as described above, according to the hook means 30, as the pressing action is performed in a vertical direction between the arm-roll vehicle 10 and the container 20, the property of responding to vertical force such as shock or vibration generated during the driving of the arm-roll vehicle 10 is exhibited.

The extension catch means 40 includes a second cylinder 42 configured on one side of the arm-roll vehicle 10, a second piston 44 configured on one side of the second cylinder 42, and an insertion protrusion 46 configured at an end of the second piston 44.

The second cylinder 42 is configured on one side of the arm-roll vehicle 10 and performs the function of providing reciprocating transfer force by hydraulic pressure provided from the outside.

The second piston 44 is configured at one end of the second cylinder 42 and performs the function of being transferred in a reciprocating manner by reciprocating transfer force provided by the second cylinder 42.

The insertion protrusion 46 is configured at the end of the second piston 44 and performs the function of being transferred in a reciprocating manner by reciprocating transfer force applied by the second piston 44.

Furthermore, while the insertion protrusion 46 is reciprocated by the second piston 44, it is inserted into or removed from an insertion hole 26 formed on one side of the container frame 24 of the container 20, so that horizontal fixing force is provided between the arm-roll vehicle 10 and the container 20.

In this case, the insertion hole 26 has a structural relationship that allows the insertion protrusion 46 to enter and exit smoothly and to exert secure fixing force when the insertion protrusion 46 enters the insertion hole 26.

In this case, an end of the insertion protrusion 46 is chamfered or rounded such that the entry into the insertion hole 26 is smoothly performed.

Accordingly, the catch means 40 provides horizontal fixing force between the arm-roll vehicle 10 and the container 20.

Therefore, the container 20 mounted on the arm-roll vehicle 10 is prevented from being pushed backward or forward due to the vibration or shock generated during the driving of the arm-roll vehicle 10.

As described above, the safety securing structure device for an arm-roll vehicle includes the hook means 30 providing vertical fixing force between the arm-roll vehicle 10 and the container 20 and the catch means 40 providing horizontal fixing force.

Furthermore, the hook means 30 is configured on the front and rear portions between the arm-roll vehicle 10 and the container 20, and the container 20 is not shaken up or down due to the vibration or shock generated during the driving of the arm-roll vehicle 10 and the arm-roll vehicle remains securely fixed to the arm-roll vehicle 10 to ensure the stable driving of the arm-roll vehicle.

It is obvious that the present invention is not limited thereto, and the hook means 30 may be configured in either the front or rear portion of the arm-roll vehicle 10 and the container 20 or may be configured on one side.

In other words, the hook means 30 may be used in any position as long as the container 20 is not interfered with by the vibration or shock generated during the driving of the arm-roll vehicle 10 and maintains a securely fixed state in the position.

Furthermore, the catch means 40 is configured on one side of the arm-roll vehicle 10 and the container 20, so that the container 20 is not shaken forward or backward due to the vibration or shock generated during the driving of the arm-roll vehicle 10 and maintains the state of being securely fixed to the arm-roll vehicle 10.

It is obvious that it is not limited thereto and the catch means 40 may be configured in any one or both of the front, intermediate and rear portions between the arm-roll vehicle 10 and the container 20.

In other words, the catch means 40 may be used in any position as long as the container 20 is not interfered with by the vibration or shock generated during the driving of the arm-roll vehicle 10 and maintains a horizontally securely fixed state in the position.

Furthermore, the hook means 30 and the catch means 40 are preferably used in combination for the arm-roll vehicle 10 and the container 2. However, the present invention is not limited thereto, and may be configured using only one of the hook means 30 or the catch means 40.

The embodiment that has been described above is merely one embodiment for implementing the safety securing structure device for an arm-roll vehicle, and the present invention is not limited to the above-described embodiment. Those of ordinary skill in the art to which the present invention pertains will appreciate that various modifications may be practiced without departing from the gist of the present invention.

1. A safety securing structure device for a container of an arm-roll vehicle, the safety securing structure device maintaining a fixed state when the container is mounted on the arm-roll vehicle in order to collect waste such as solid or liquid waste, sludge, etc., the safety securing structure device comprising:
at least one hook means (30) for providing vertical fixing force between the arm-roll vehicle (10) and the container (20).

2. The safety securing structure device of claim 1, comprising:
at least one catch means (40) for providing horizontal fixing force between the arm-roll vehicle (10) and the container (20).

3. The safety securing structure device of claim 1, wherein the hook means (40) comprises:
a first cylinder (32) fixed to one side of the arm-roll vehicle (10), and configured to provide reciprocating force;
a first piston (34) configured at one end of the first cylinder (32), and configured to be reciprocated by the reciprocating force provided by the first cylinder (32); and
a hook bracket (36) configured at one end of the first piston (34), and configured to be rotated by a predetermined angle in response to the reciprocation of the first piston (34) and selectively press and release pressing of the container frame (24) of the container (20) mounted on the arm-roll vehicle (10).

4. The safety securing structure device of claim 3, wherein the hook bracket (36) comprises:
a first hinge (38) configured to provide support to be hinged to the first piston (34); and
a second hinge (39) configured to provide support to be hinged to one side of the arm-roll vehicle (10) so that a reaction occurs in the hook bracket (36) in response to a forward or backward action of the first piston (34), thereby allowing a pressing or releasing action of the container frame (24) to be smoothly performed.

5. The safety securing structure device of claim 2, wherein the catch means (40) comprises:
a second cylinder (42) configured on one side of the arm-roll vehicle (10), and configured to provide reciprocating transfer force;
a second piston (44) configured at one end of the second cylinder (42), and configured to be transferred in a reciprocating manner by the reciprocating transfer force provided by the second cylinder (42); and
an insertion protrusion (46) configured at one end of the second piston (44), and configured to provide support so that horizontal fixing force is applied to the container (20) while being transferred in a reciprocating manner in response to the reciprocation of the second piston (44).

6. The safety securing structure device of claim 5, wherein an insertion hole (26) configured such that the insertion protrusion (46) enters thereto and exits therefrom so that a horizontal fixed state is maintained between the arm-roll vehicle (10) and the container (20) is formed on one side of the container frame (24).
